(19) United States
(12) Patent Application Publication
(10) Pub. No.: US 2012/0215143 A1
(43) Pub. Date: Aug. 23, 2012

(54) MASSAGE MACHINE

(75) Inventors: Nichimu INADA, Osaka (JP); Yoshifumi Fukuyama, Tottori (JP); Tomohisa Shirakawa, Tottori (JP)

(73) Assignee: Family Co., Ltd., Osaka (JP)

(21) Appl. No.: 13/403,383

(22) Filed: Feb. 23, 2012

(30) Foreign Application Priority Data
Feb. 23, 2011 (JP) 2011-037124

(51) Int. Cl. A61H 15/00

(52) U.S. Cl. 601/112

(57) ABSTRACT

The massage mechanism includes inner treatment elements, outer treatment elements and a driving device that drives the treatment elements. A distance between the inner treatment elements and the outer treatment elements is changed by the driving device. A first supporting shaft supports the inner and the outer treatment elements and is rotated about an axial center by the driving device. The first supporting shaft includes inner inclined shafts that support the inner treatment elements via an arm and outer inclined shafts that support the outer treatment elements via the arm. The massage mechanism is configured to be movable from a backrest part to a footrest part via a seat part.

### CROSS-REFERENCES TO RELATED APPLICATION

This application claims priority from Japanese Patent Application No. 2011-037124 filed Feb. 23, 2011, the contents of which are incorporated herein by reference in their entirety.

### TECHNICAL FIELD

The present invention relates to a massage machine which can perform a satisfactory massage on a person from the upper body to the lower body.

### BACKGROUND

A chair-type massage machine for massaging a person is described, for example, in Japanese Patent Unexamined Application Publication No. 2004-283266, for example).

Further, a chair-type massage machine that includes treatment portions that correspond only to the left and right halves of the upper body is described, for example, in Japanese Patent Unexamined Application Publication No. 2009-254408.

Furthermore, a leg massage machine that massages the left and right legs of a person is described, for example, in Japanese Registered Utility Model No. 3157571.

Yet, according to the chair-type massage machine disclosed in Japanese Patent Unexamined Application Publication No. 2004-283266, it is not possible to perform a satisfactory massage (such as kneading or the like) corresponding to the left and right halves of the body due to narrow treatment ranges of the body. Further, according to the chair-type massage machine disclosed in Japanese Patent Unexamined Application Publication No. 2009-254408, it is not possible to perform a satisfactory massage (such as kneading or the like) corresponding to each leg while massaging the upper body.

Consistently, it is not possible to massage (such as kneading or the like) on the upper body while messaging the legs. That is, according to the leg massage machine disclosed in Japanese Registered Utility Model No. 3157571, it is not possible to massage (such as kneading or the like) the upper body while messaging each of the legs.

### SUMMARY OF THE INVENTION

The present invention relates to a message machine comprising a main chair body including a seat part, a backrest part, and a footrest part; and a massage mechanism provided in the main chair body that is movable along a path between the backrest part and the footrest part. The massage mechanism includes: a pair of first and second inner treatment elements; a pair of first and second outer treatment elements, wherein the pair of the inner treatment elements are between the pair of outer treatment elements; and a driving device that drives the pair of inner treatment elements and the pair of outer treatment elements; and a first supporting shaft that supports the pair of inner treatment elements and the pair of outer treatment elements and is rotated about an axial center by the driving device. The first supporting shaft includes: a pair of inner inclined shafts that respectively support the inner treatment elements via an arm; and a pair of outer inclined shafts that respectively support the outer treatment elements via the arm; wherein the pair of the inner inclined shafts have different angles with respect to the axial center, one of the inner inclined shafts and one of the outer inclined shafts have different angles with respect to the axial center; wherein a first distance between the first inner treatment element and the first outer treatment element is variable by the driving device in the first direction and a second distance between the second inner treatment element and the second outer treatment element is variable by the driving device in the first direction; and wherein the massage mechanism is movable from the backrest part to the footrest part via the seat part.

Further, a guide rail may extend in a height direction of the main chair body along the seat part, the backrest part and the footrest to guide the movement of the massage mechanism.

Furthermore, the massage machine may comprise a second supporting shaft, which respectively supports the inner treatment elements and the outer treatment elements and is rotated about the axial center by the driving device. The second supporting shaft may include: a pair of inner eccentric shafts that supports the pair of the inner treatment elements via the arm; and a pair of outer eccentric shafts that supports the pair of the outer treatment elements via the arm; wherein the pair of the inner eccentric shaft are eccentric with respect to the axial center such that the phases about the axial center are different from each other, one of the inner inclined shafts and one of the outer eccentric shafts are eccentric with respect to the axial center such that the phases about the axial center are different from each other; and wherein the pair of inner treatment elements and the pair of outer treatment elements alternately protrude.

Moreover, the main chair body may includes a body supporting part that is entirely or partially flexible and is configured to support a back surface of a person and, wherein the body supporting part is set to have a smaller degree of flexibility in a part configured to be set near knees of the person as compared with the other parts.

The main chair body may alternatively include a body supporting part that supports the back surface of the person and that is entirely or partially flexible, wherein the seat part has an inclined shape in which the front thereof is higher and the footrest has an inclined shape in which the front thereof is the lower, and wherein the body supporting part is set to have a smaller degree of flexibility near a boundary portion between the seat part and the footrest part as compared with the other parts.

The main chair body may alternatively include a body supporting part that supports the back surface of the person and that is entirely or partially flexible, comprising: a main body cover covering a front side of the massage mechanism, and a belt member partially provided in front of and separate from the main body cover, wherein the degree of the flexibility in the belt member is set to be smaller than that in the main body cover.

The pair of inner treatment elements may be provided on both left and right sides of the arm to perform a pinch action.

The described may be embodied in various forms, including benches, tables, sofas, transportation seats, and the like.

### BRIEF DESCRIPTION OF THE DRAWINGS

FIG. 1 is a perspective view of a massage machine in a front position state;

FIG. 2 is a perspective view of a massage machine in a front position state in which a body supporting part is separated;

FIG. 3 is a side view of a massage machine in a front position state.

FIG. 4 is a side view of a massage machine in a back position state.

FIG. 5 is a block diagram showing a configuration of a massage machine.

FIG. 6 is a perspective view of an appearance of a massage mechanism when viewed from a front obliquely upward direction;

FIG. 7 is a perspective view of an appearance of a massage mechanism when viewed from a back obliquely upward direction;

FIG. 8 is a perspective exploded view of a configuration of a part of a massage mechanism.

FIG. 9 is a perspective exploded view of a part of a first supporting shaft;

FIG. 10 is a perspective exploded view of a part of a second supporting shaft;

FIGS. 11A and 11B are planar enlarged views of parts of a first supporting shaft and a second supporting shaft, where FIG. 11A shows the first supporting shaft and FIG. 11B shows the second supporting shaft;

FIGS. 12A and 12B are planar views illustrating operations of an inner treatment element and an outer treatment element when a first supporting shaft is rotated, where FIG. 12A shows a state in which the inner treatment element and the outer treatment element are in positions close to each other and FIG. 12B shows a state in which the inner treatment element and the outer treatment element are separated from each other;

FIGS. 13A and 13B are diagrams for illustrating the operations of the treatment elements for a person's legs, where FIG. 13A is a diagram schematically showing a main chair body when viewed from a side of toes and FIG. 13B is a diagram schematically showing the main chair body when viewed from a left side;

FIG. 14 is a planar view showing another configuration which can be applied to a massage mechanism; and

FIGS. 15A and 15B are planar views schematically showing a positional relationship between a leg frame and a main body frame, where FIG. 15A shows a state in which a main chair body is in a front position or a first predetermined position and FIG. 15B shows a state in which the main chair body is in a back position or a first predetermined position.

### DESCRIPTION OF THE INVENTION

In view of the above, the present invention relates to massage machine that performs massages corresponding to each of the left and right halves of the upper body of a person, to the muscles of the back, and to each leg to perform a satisfactory massage from the upper to lower body.

More particularly, the present invention relates to a message machine comprising a main chair body including a seat part, a backrest part, and a footrest part; and a massage mechanism provided in the main chair body that is movable along a path between the backrest part and the footrest part, including: a pair of inner treatment elements that includes a first inner treatment element and a second inner treatment element; a pair of outer treatment elements that includes a first outer treatment element and a second outer treatment element, where the paired of inner treatment elements are between the pair of outer treatment elements; and a driving device that drives the pair of inner treatment elements and the pair of outer treatment elements; and a first supporting shaft that supports the pair of inner treatment elements and the pair of outer treatment elements and is rotated about an axial center by the driving device, including: a pair of inner inclined shafts that respectively support the inner treatment elements via an arm; and a pair of outer inclined shafts that respectively support the outer treatment elements via the arm, where the inner inclined shafts and the outer inclined shafts have different angles with respect to the axial center, wherein a first distance between the first inner treatment element and the first outer treatment element is variable by the driving device in the first direction and a second distance between the second inner treatment element and the second outer treatment element is variable by the driving device in the first direction.

With such a configuration, it is possible to perform kneading massage on each of the left and right halves of the upper body to independently pinch each of the left and right halves and perform kneading massage on the back muscles in the horizontal direction when the massage mechanism is positioned in the backrest part. Further, it is possible to perform kneading massage to independently pinch each of the left and right legs when the massage mechanism is positioned in the footrest. And since the massage mechanism is movable from the backrest part to the footrest, the inner treatment elements and the outer treatment elements may mutually approach and separate from each other. In addition, the massage mechanism may now be guided from the backrest part to the footrest via the seat part. Further, the message mechanism may independently perform a tapping massage on each of the left and right halves of the upper body, on the muscles of the back in the horizontal direction, and on each leg. This configuration may also guide the knees near the boundary of the seat part and the footrest for proper positioning the knees with respect to the main chair body to prevent the knees from sinking downward in the main chair body, and thus avoiding a massage on the side portions of the knees (as massages on the side portions of the knees is usually accompanied by pain).

Further, a belt member may be employed to prevent the body from sinking in the main chair body, stably support the body, and provide sufficient massage via the main cover body. The belt member is constructed so as not to trap the treatment elements during operations of the massage mechanism.

Furthermore, the message mechanism may be guided such that the inner treatment elements precisely abut on the inner sides of the legs when the massage mechanism is positioned in the footrest. Additionally, the inner treatment elements may precisely abut on the center back muscles when the massage mechanism is positioned in the backrest portion. Thus, a satisfactorily kneading massage may be performed on each of the leg and the center back muscles.

Thus, because of the described orientations it is possible to perform a massage over a wide body range even if only one massage mechanism is provided.

### Overall Configuration

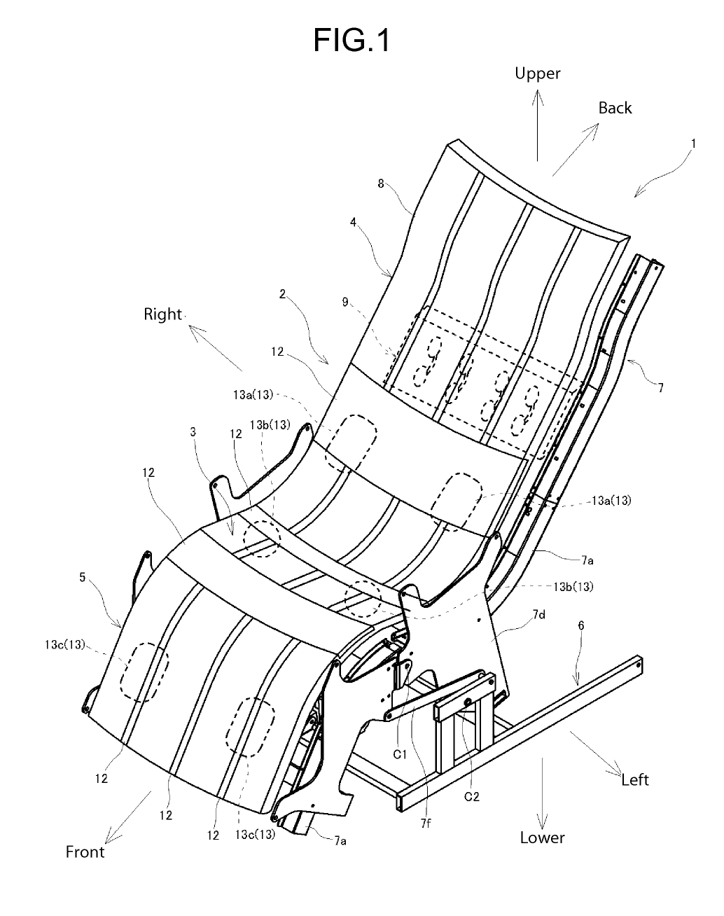

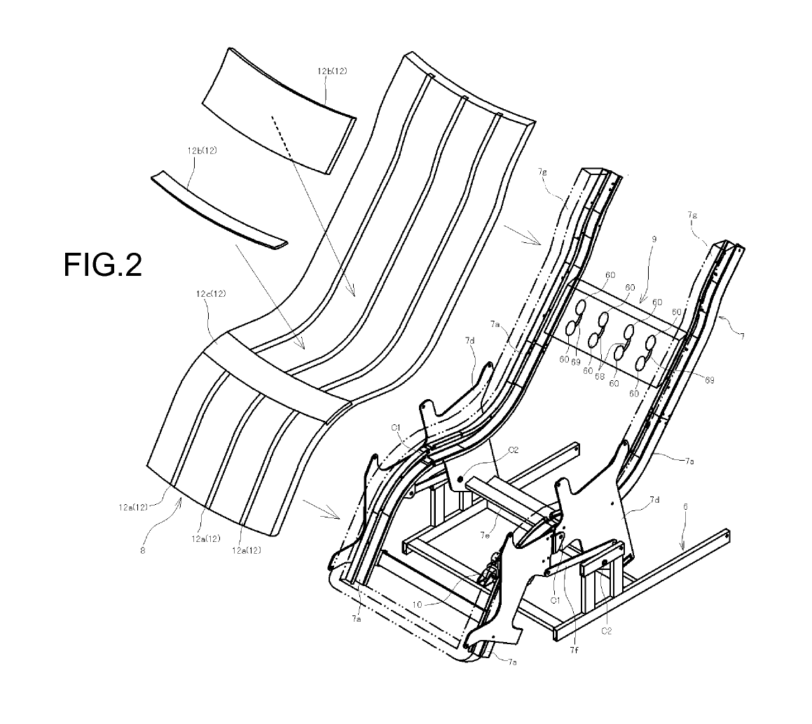

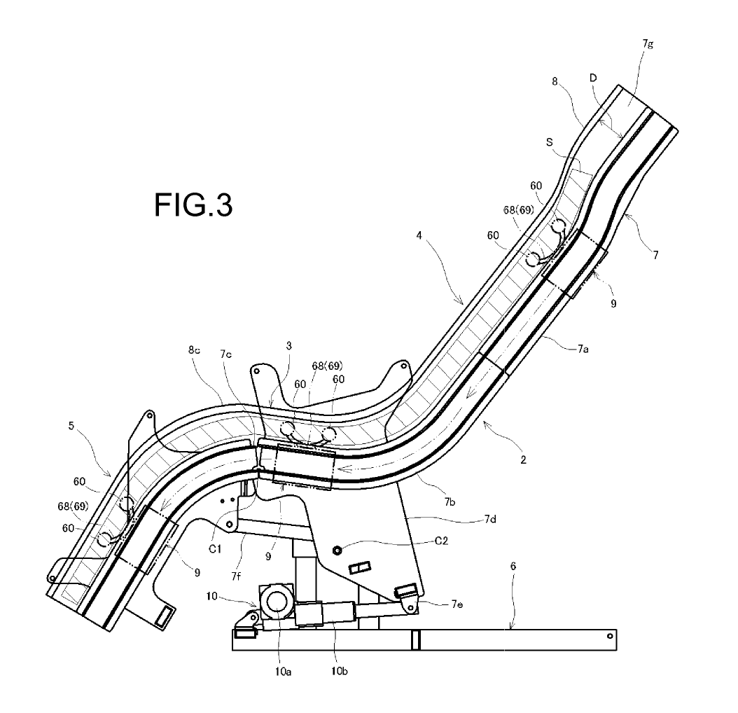

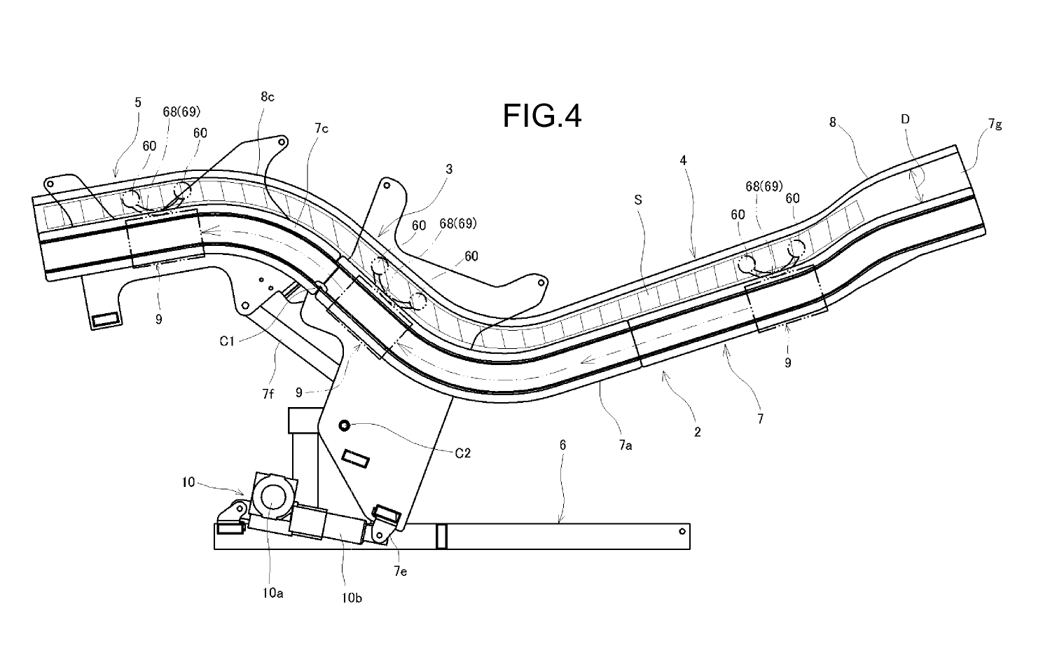

Hereinafter, description will be made of an overall configuration of a massage machine. FIG. 1 is a perspective view of a massage machine in a front position state. FIG. 2 is a perspective view of a massage machine in a front position state in which a body supporting part is separated. FIG. 3 is a side view of a massage machine in a front position state. FIG. 4 is a side view of a massage machine in a back position state.

Specifically, FIG. 1 is a perspective view of the massage machine 1 in a front position state. FIG. 2 is a perspective view of the massage machine in the front position state in which a body supporting part 8 is separated. FIG. 3 is a side view of a massage machine in a front position state. FIG. 4 is a side view of a massage machine in a back position state. An air cell 13, which will be described later, is omitted in FIGS. 2 to 4 in consideration of visibility.

As shown in FIGS. 1 to 4, the massage machine 1 according to the present invention is mainly provided with a main chair body 2 including a seat part 3 on which a person is seated, a backrest part 4 that is integrally provided on the back portion of the seat part 3 on which a person leans, and a footrest 5 that is provided on the front portion of the seat part 3. The footrest may be vertically swung while supporting the legs. A leg frame 6 supports the main chair body 2, such that the main chair body 2 may swing in a front-to-back direction. In addition, the main chair body 2 is provided with a massage mechanism 9 and an air cell 13 that are movable from the backrest part 4 to the foot rest 5 via the seat part 3 to perform a massage or treat specific parts of a person. The massage mechanism 9 permits performance of a massage on the neck to the toes of a person by moving the massage mechanism 9 in a height direction of the person. Moreover, the directions described above and used in the following description are the same whether viewed from a sitting or lounging main chair body position, and description will be appropriately made in other cases.

### Configuration of Main Chair Body

The configuration of the main chair body 2 will be described in detail. The main chair body 2 includes a main body frame 7 comprising a pair of guide rails 7a on both left and right end portions of the frame and a body supporting part 8 to support the body of a person. The guide rails 7a extend along the height direction of a person and are configured to guide the movement of the massage mechanism 9. In addition, the guide rails 7a of the backrest part 4 and the seat part 3 are sequentially configured via a curved part 7b formed near the respective boundary portions, and the guide rails 7a of the footrest 5 and the seat part 3 are coupled via a rotation shaft C1 near the respective boundary portions. Thus, the guide rail 7a of the footrest 5 may vertically swing within a predetermined range about a rotation shaft C1 with respect to the guide rail 7a of the seat part 3. In addition, a curved part 7c is also formed near the boundary portion between the guide rail 7a of the footrest 5 and the guide rail 7a of the seat part 3. Since there are curved parts 7b and 7c near the boundary portion between the guide rail 7a of the backrest part 4 and the guide rail 7a of the seat part 3 and near the boundary portion between the guide rail 7a of the footrest 5 and the guide rail 7a of the seat part 3, respectively, the massage mechanism 9 smoothly moves between the backrest part 4 and the footrest 5 via the seat part 3. In addition, the guide rails 7a of the footrest 5 and the seat part 3 may be sequentially configured via the curved part 7c in the same manner as in the guide rails 7a of the backrest part 4 and the seat part 3.

The configuration of the main body frame 7 will be described in detail. The main body frame 7 is provided with a pair of left and right guide rails (guide rails of the seat part 3) 7a, a pair of left and right supporting members 7d that support in a rotatable fashion the guide rails 7a at the leg frame 6 via the rotation shaft C2, a coupling member 7e that extends in the horizontal direction for coupling both the supporting members, a link member 7f that couples the supporting member 7d with the guide rail 7a of the footrest 5 and effects vertically a swing for the footrest 5 with respect to the seat part 3 in conjunction with the vertical swing of the main body frame 7, and a supporting member 7g (see FIGS. 2, 3, and 4; this is shown by a two-dotted chain line in consideration of visibility in FIG. 2) that supports the body supporting part 8 with a predetermined distance D from the guide rail 7a in the vertical direction. A swing driving part 10 that swings the main body frame 7 about the rotation shaft C2 with respect to the leg frame 6 in the front-back direction is interposed between the main body frame 7 and the leg frame 6. The swing driving part 10 is configured by an actuator in which a rod 10b is driven (extended and contracted) by a motor 10a. The front end portion of the rod 10b is attached to the leg frame 6. The back end portion is attached to the coupling member 7e of the main body frame 7.

If this rod 10b is extended, the main chair body 2 swings forward about the rotation shaft C2 with respect to the leg frame 6 as a whole from the back position state shown in FIG. 4 and the footrest 5 swings downward about the rotation shaft C1 with respect to the seat part 3 to be in the front position state shown in FIG. 3. On the other hand, if this rod 10b is contracted, the main chair body 2 swings backward about the rotation shaft C2 with respect to the leg frame 6 as a whole from the front position state shown in FIG. 3 and the footrest 5 swings upward about the rotation shaft C1 with respect to the seat part 3 to be in the back position state shown in FIG. 4. In addition, the main chair body 2 may be restricted at an arbitrary position in the front-back direction between the front position state and the back position state by controlling the amount of extension of the rod 10b. Moreover, the main chair body 2 may also perform a rocking operation by repeatedly performing extension and contraction of the rod 10b.

As shown in FIGS. 3 and 4, the seat part 3 is configured to have an inclined shape in which the front thereof is higher, and the footrest 5 is configured to have an inclined shape in which the front thereof (the side of toes) is lower. That is, a convex curved part 7c is formed near the boundary portion between the seat part 3 and the footrest 5. Therefore, a person can easily position the back surfaces of knees at this curved part 7c when seated on the massage machine 1.

As shown in FIG. 2, the body supporting part 8 includes a main body cover 11 made of flexible fabric or the like that is stretched over the main body frame 7 with predetermined tension and a belt member 12 that is stretched in the same manner as in the main body cover 11. The body supporting part 8 is configured to support a person from the upper body to the lower body. In addition, as shown in FIGS. 3 and 4, the body supporting part 8 is stretched over the main body frame 7 (supporting member 7g) with a predetermined distance D in the vertical direction with respect to the guide rail 7a. The massage is performed on the person by the massage mechanism 9 via the body supporting part 8. The belt member 12 includes a first belt member 12a, a second belt member 12b, and a third belt member 12c. The first belt member 12a is sewn and integrally formed into the main body cover 11 and stretched from the backrest part 4 to the footrest 5 in the height direction. The second belt member 12b is positioned (and separately provided) in front of the main body cover 11 and stretched over the lower back position in the backrest part 4 and the seat part 3 in the horizontal direction. The third belt member 12c is sewn and integrally formed into the main body cover 11 and stretched near the boundary portion (curved part 7c) between the seat part 3 and the footrest 5. In addition, the degrees of flexibility of the main body cover 11 and each of the belt members 12a to 12c are set to satisfy:
main body cover 11 flexibility degree>first belt member 12a flexibility degree;
first belt member 12a flexibility degree>second belt member 12b flexibility degree; and
second belt member 12b flexibility degree>third belt member 12c flexibility degree.

In this body supporting part 8, the first supporting portion over which the belt member 12 is stretched has a lower degree of flexibility as compared with the second supporting member (a portion configured only by the main body cover 11) over which the belt member 12 is not stretched, which causes a person to sink downward (in an operation area S in which arms 68 and 69 and a treatment element 60 included in the massage mechanism 9 are operated) to a small extent when seated on the massage machine 1. Specifically, the movement region S is a three-dimensional space surrounded by an operable range of the treatment element 60 and the arms 68 and 69 in the horizontal direction, an operable range in the vertical direction, and an operable range in the height direction. In addition, the treatment element 60 included in the massage mechanism 9 is positioned at the second supporting portion in the vertical direction. Specifically, a pair of inner treatment elements 61a and 62a is respectively positioned between the first belt member 12a at the center in the horizontal direction and the left and right outer first belt members 12a when viewed from the front direction, and a pair of outer treatment elements 61b and 62b is respectively positioned outside the left and right outer first belt members 12a in the horizontal direction when viewed from the front direction. In addition, the first belt member 12a may be configured only by one belt member at the center in the horizontal direction.

Thus, the body supporting portion 8 may stably support the body of the person by the first supporting portion and the massage mechanism 9 may provide a sufficient massage since the body of the person correctly sinks into the operation region S in the second supporting portion. Further, the amount by which the knees sink into the operation region S is reduced. Furthermore, the side portions of the knees are avoided since the degree of flexibility in the curved part 8c formed near the boundary portion between the seat part 3 and the footrest 5 in the body supporting portion 8 is set to be smaller than those of other parts (configured by the first supporting portion including the third belt member 12c). Thus, a massage on the side portions of the knees that is usually accompanied by pain is not performed. The body supporting part 8 may be configured such that a rigid member (synthesis resin or the like, for example) made by blow molding or the like is provided instead of the third belt member 12c provided in the curved part 8c near the boundary portion between the seat part 3 and the footrest 5. Since the second belt member 12b is positioned at the front of the main body cover 11, separately configured from the main body cover 11, and set to have a smaller degree of flexibility as those of the main body cover 11 and the first belt member 12a, the lower back and the hips are stably supported at a further front portion than the main body cover 11 and a trapping of treatment element 60 by the second belt member 12b due to the operations (the movement in the height direction, the kneading operation, the tapping operation, and the like) of the massage mechanism 9 provided in the back portion of the body supporting part 8 is prevented. Moreover, because the weight of the person most strongly acts on the seat part 3 when the main chair body 2 is in the front position state while the weight of the person most strongly acts on the backrest part 4 (in the lower back portion, in particular) when the main chair body 2 is in the back position state, the body is stably supported by the second belt member 12b in both states.

As shown in FIG. 1, a pair of left and right air cells 13 that is expand and contract by air supply and discharge to perform massage on corresponding treated parts is provided in each of the parts (the backrest part 4, the seat part 3, and the footrest 5 in this embodiment) of the main chair body 2. The air cells 13a provided in the backrest part 4 are for pressing the back of the person from the back direction. The air cells 13b provided in the seat part 3 expand from the lower direction for pressing the hip to pinch the hips substantially from the left and right directions. The air cells 13c provided in the footrest 5 expand from the lower direction for pressing the legs substantially from the front direction. Although the air cells 13 are provided in the body supporting part 8 in this embodiment, the air cells 13 may be provided in the main body frame 7 (supporting member 7g).

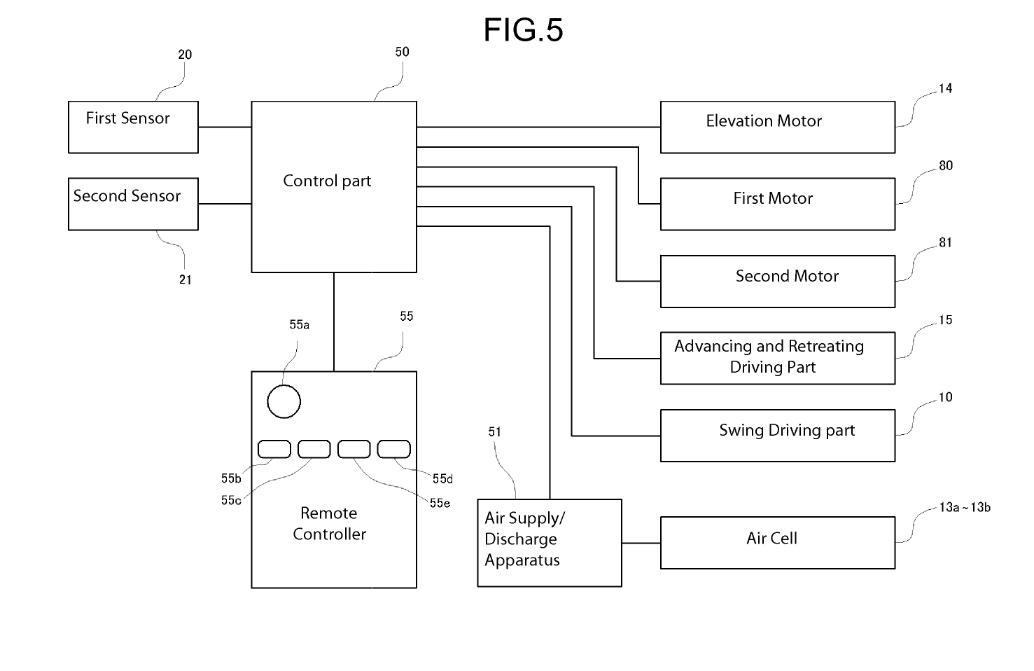

FIG. 5 is a block diagram showing a configuration of a massage machine. As shown in FIG. 5, each of the aforementioned air cells 13a to 13c is connected to an air supply/discharge apparatus 51 including a pump and a valve or the like via a flexible hollow air tube. This air supply/discharge apparatus 51 is accommodated in the lower portion of the seat part 3, driven in response to the instruction from a control part 50 accommodated in the lower portion of the seat part 3 in the same manner and can independently supply and discharge air to each of the air cells 13a to 13c. In addition, it is possible to perform a pressing treatment on any parts of the a person's body by driving the air supply/discharge apparatus 51 based on instructions from the control part 50 and expanding and contracting the air cells 13a to 13c, accordingly.

The air supply/discharge apparatus 51 can be operated not only by a program set in advance or in response to instructions from the control part 50. Further, instruction may be based on a signal input to the control part 50 by the operation of the remote controller 55 connected to the control part 50 by a person. Similarly, the operations of the massage mechanism 9 and a swing driving part 10 (described later) can be operated by a program set in advance in response to the instruction from the control part 50 or based on the signal input to the control part 50 by the operation of the remote controller 55 by the person.

In addition, the control part 50 has a memory (not shown), and the memory stores a plurality of massage programs (courses) for instructing massages on the treated parts by the massage mechanism 9 and the air cells 13a to 13c. Moreover, the remote controller 55 has a power button 55a and a plurality of course buttons 55b to 55e corresponding to each massage program. The corresponding massage program is executed by operating one of the course buttons 55b to 55e.

### Configuration of Massage Mechanism

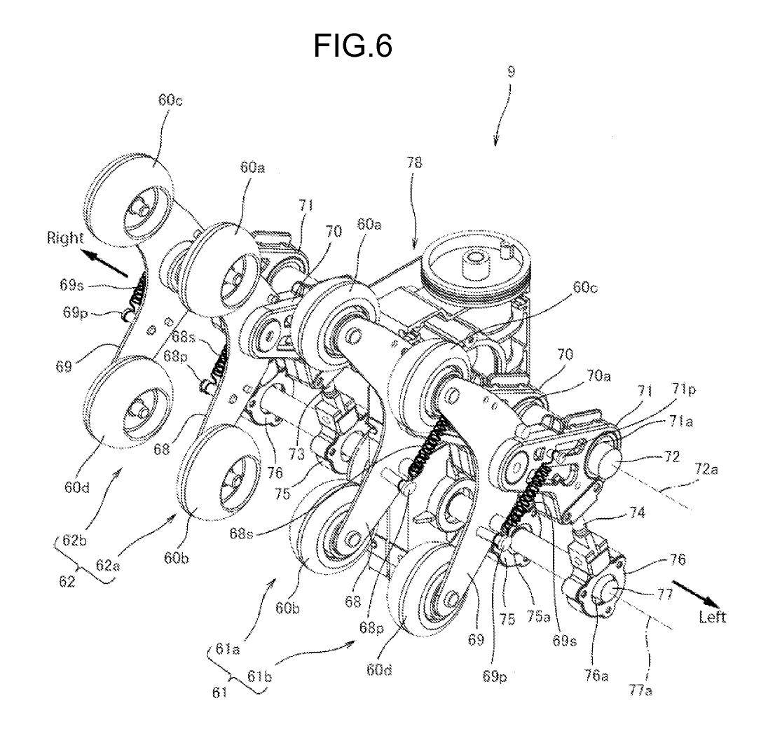

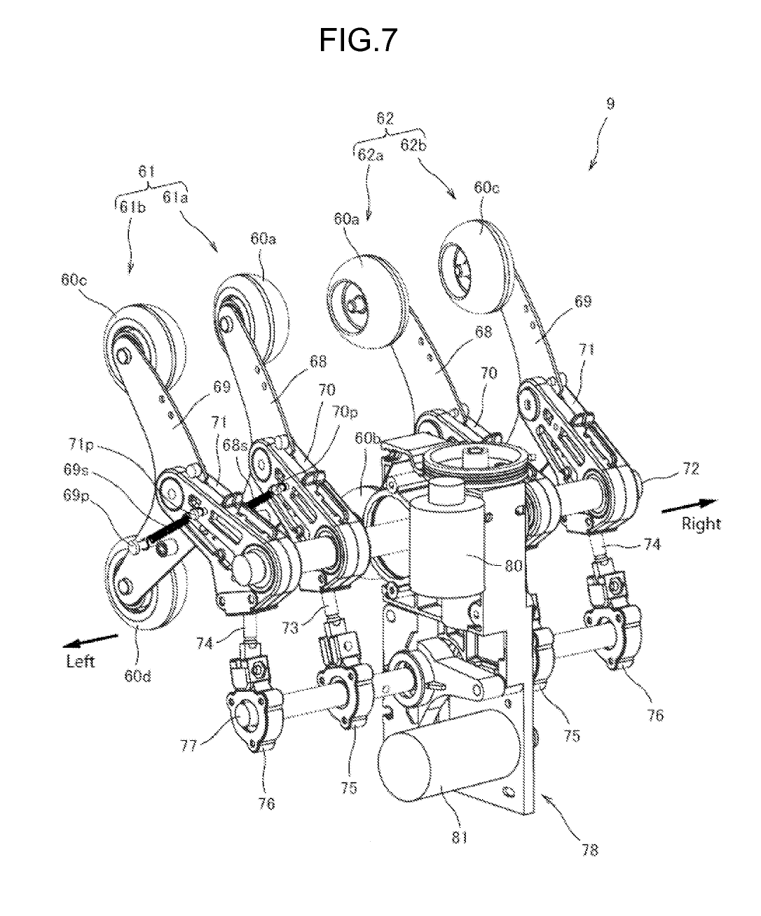

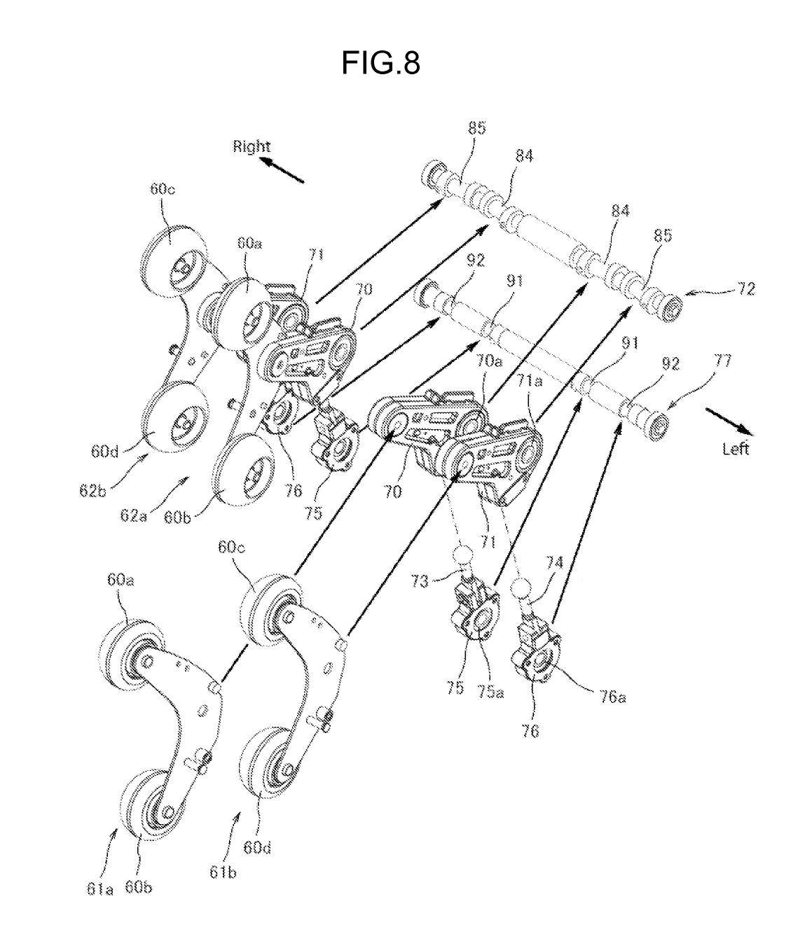

Hereinafter, description will be made of a configuration of the massage mechanism 9 provided in the main chair body. FIG. 6 is a perspective view of an appearance of a massage mechanism when viewed from a front obliquely upward direction. FIG. 7 is a perspective view of an appearance of a massage mechanism when viewed from a back obliquely upward direction. Specifically, FIG. 6 is a perspective view of an appearance of the massage mechanism 9 when viewed from a front obliquely upward direction, and FIG. 7 is a perspective view of the appearance when viewed from a back obliquely upward direction. In addition, FIG. 8 is a perspective exploded view of a configuration of a part of a massage mechanism.

The massage mechanism 9 has eight treatment elements 60 (see FIG. 1 as well) and disposed in the vertical and horizontal directions, the treatment elements 60 is driven by a motor constituting or driving device and operated in a three-dimensional manner to perform various kinds of pressing treatment, such as kneading, tapping, and shiatsu on the back surface of the person from the upper body to the lower body. A pinion (not shown) included in the massage mechanism 9 is engaged with a rack (not shown) included in the guide rail 7a, and the massage mechanism 9 having such treatment elements 60 can be moved in the height direction within the main chair body 2 when the pinion is driven and rotated by an elevation motor 14 (see FIG. 5). Therefore, it is possible to perform a rolling massage on the back of a person the upper to the lower body (that is, from the neck portion to the toes by moving the massage mechanism 9). The rotation direction and the rotation speed of the output shaft in the elevation motor 14 are controlled by a signal from the control part 50 (see FIG. 5).

In addition, the massage mechanism 9 is configured to advance and retreat with respect the treated parts by an advancing and retreating driving part 15. This advancing and retreating driving part 15 may be configured by an air cell that is provided on the side surface of the massage mechanism 9 or by a rack and pinion mechanism provided on the side surface of the massage mechanism 9. In such a case, the massage mechanism 9 can press the treated parts of the person, whose body is being supported by the main chair body 2, from the back surface. This advancing and retreating driving part 15 is configured to allow the massage mechanism 9 to advance and retreat by a signal from the control part 50 (see FIG. 5).

As shown in FIGS. 6 to 8, the massage mechanism 9 is provided with a left treatment element 61 including an inner treatment element 61a and an outer treatment element 61b corresponding to the left side of the upper body (hereinafter, referred to as a “left half of the body”) or the left leg of the person and a right treatment element 62 including an inner treatment element 62a and an outer treatment element 62b corresponding to the right side of the upper body (hereinafter, referred to as a “right half of the body”) or the right leg. Among them, the inner treatment element 61a includes an upper treatment element 60a and a lower treatment element 60b, and the treatment elements 60a and 60b are pivoted at the upper and lower tip ends of an arm 68 with a substantially ‘v’ shape. Similarly, the outer treatment element 61b includes an upper treatment element 60c and a lower treatment element 60d, and the treatment element 60c and 60d are pivoted at the upper and lower tip ends of an arm 69 with a substantially ‘v’ shape. In addition, the inner treatment element 62a and the outer treatment element 62b corresponding to the right half of the body have the same configurations as those of the inner treatment element 61a and the outer treatment element 61b corresponding to the left half of the body and the same symbols are given to the corresponding configurations in the drawings.

Each of the base parts of the arms 68 and 69 are supported at tip ends on one side by substantially v-shaped connecting rods 70 and 71, respectively. A pivot shaft rotates the substantially v-shaped connecting rods 70 and 71 in the horizontal direction within a predetermined angle range. In addition, pins 68p and 69p protruding outward in the horizontal direction are provided in the arms 68 and 69, and pins 70p and 71p protruding outward in the horizontal direction are provided in the connecting rods 70 and 71. Further, coil springs 68s and 69s with predetermined spring coefficients are stretched between the pins 68p and 70p and between the pins 69p and 71p, respectively. Therefore, the arms 68 and 69 are biased such that the upper treatment elements 60a and 60c direct toward the front direction (the side of the person to be treated) by the coil springs 68s and 69s. Moreover, it is possible to adjust the bias force acting on the person by the treatment elements 60a and 60c by appropriately employing different spring coefficients for the coil springs 68s and 69s. In addition, the arms 68 and 69 may be biased to be in a neutral state, in which the protruding amount of the upper treatment elements 60a and 60c is substantially equal to that of the lower treatment elements 60b and 60d in the front direction (the side of the person to be treated), by the coil springs 68s an 69s. The upper treatment elements 60a and 60c can abut on the shoulders from the substantially upper direction when the massage mechanism 9 is positioned near the shoulders. Thus, trapping the treatment elements 60a to 60d by the back surfaces of the knees when the massage mechanism passes through the part near the knees (near the curved part 7c) is prevented if the position and the bias force of the coil springs 68s and 69s are set such that the arms 68 and 69 are in the neutral state.

In each of the base parts of the connecting rods 70 and 71, bearing holes 70a and 71a are formed to penetrate therethrough in a substantially horizontal direction, and a first supporting shaft 72 with an axial center arranged in the horizontal direction is inserted into the bearing holes 70a and 71a. In addition, fitting concave portions (which are not shown) are respectively formed at the tip ends on the other side of the connecting rods 70 and 71, and one end portion of a coupling rod 73 and one end portion of a coupling rod 74 are respectively inserted into the fitting concave portion such that the fitting concave portion, the one end of the coupling rod 73, and the one end of the coupling rod 74 form an adjustable joint such as a ball joint or the like. The other end portions of the coupling rods 73 and 74 are respectively connected to bearing members 75 and 76 including bearing holes 75a and 76a penetrate in a substantially horizontal direction, and a second supporting shaft 77 with an axial center arranged in the horizontal direction is inserted into the bearing holes 75a and 76a included in the bearing members 75 and 76.

As shown in FIG. 7, the massage mechanism 9 is provided with a gear box 78. This gear box 78 is positioned between the inner treatment element 61a for the left half of the body (left leg) and the inner treatment element 62a for the right half of the body (right leg) in the horizontal direction, and the center portions of the first supporting shaft 72 and the second supporting shaft 77 extend in the horizontal direction, respectively, to penetrate therethrough. A first motor 80 and a second motor 81 are disposed near the gear box 78, and rotation directions and the rotation speeds of the output shaft of the first motor 80 and the second motor 81 are controlled by a signal from the control part 50 (see FIG. 5).

In addition, the rotation output of the first motor 80 is delivered to the first supporting shaft 72 via a worm (not shown) provided in the gear box 78 and a helical gear (not shown) that provided at the center of the first supporting shaft 72 in the horizontal direction is engaged with the worm. Therefore, the first supporting shaft 72 is rotated about the axial center 72a when the first motor 80 is driven by the instruction from the control part 50. In addition, the rotation output of the second motor 81 is delivered to the second supporting shaft 77 via a pulley and a belt (not shown) provided in the gear box 8 and a pulley provided at the center of the second supporting shaft 77 in the horizontal direction. Therefore, the second supporting shaft 77 is rotated about the axial center 77a when the second motor 81 is driven by the instruction from the control part 50.

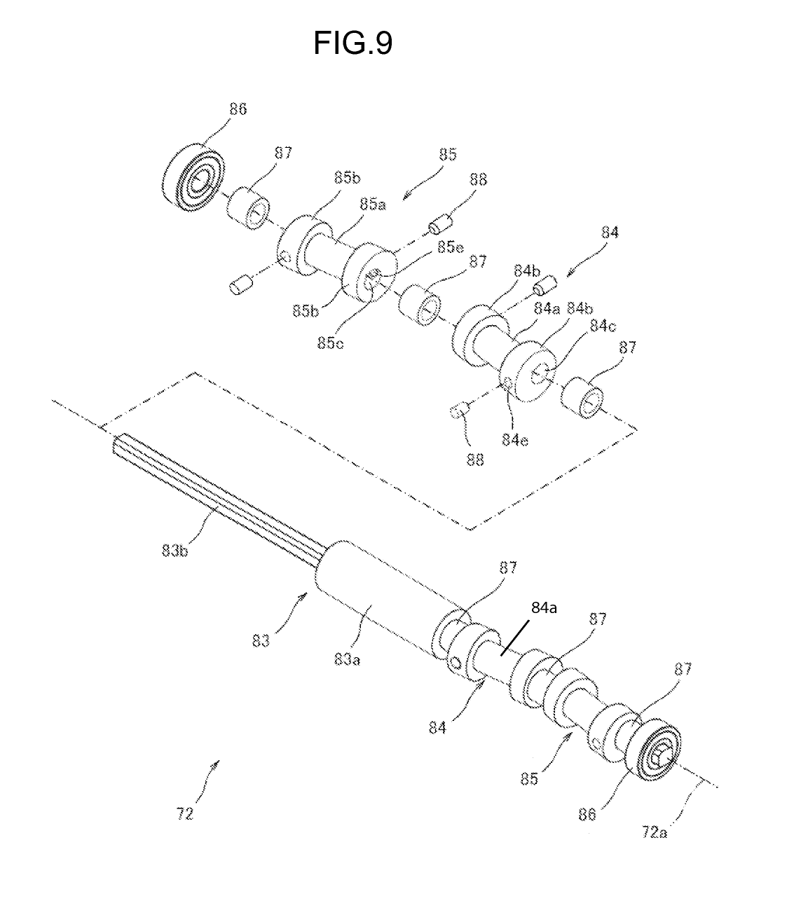

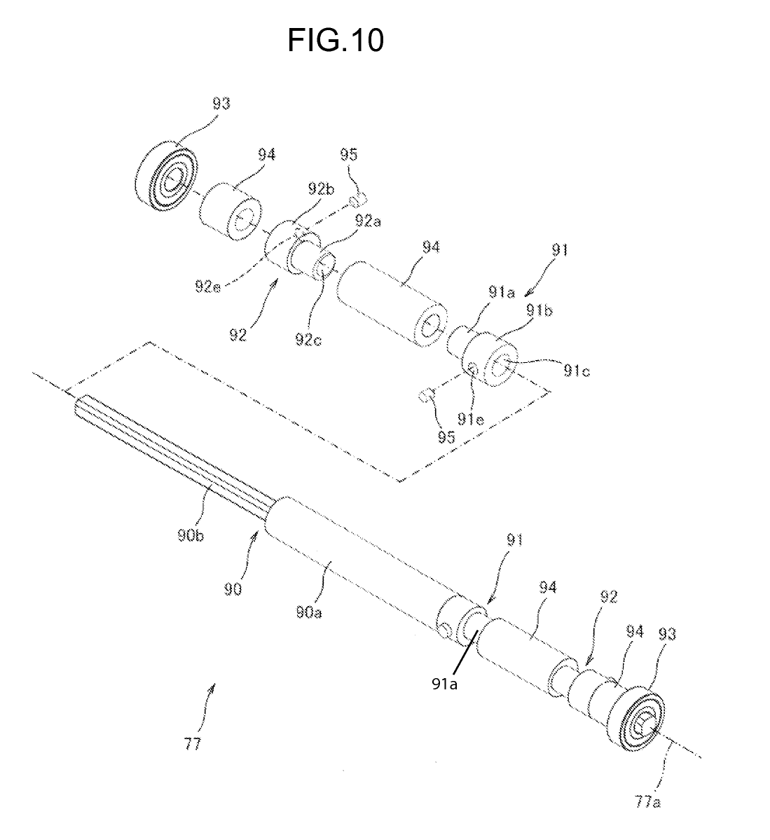

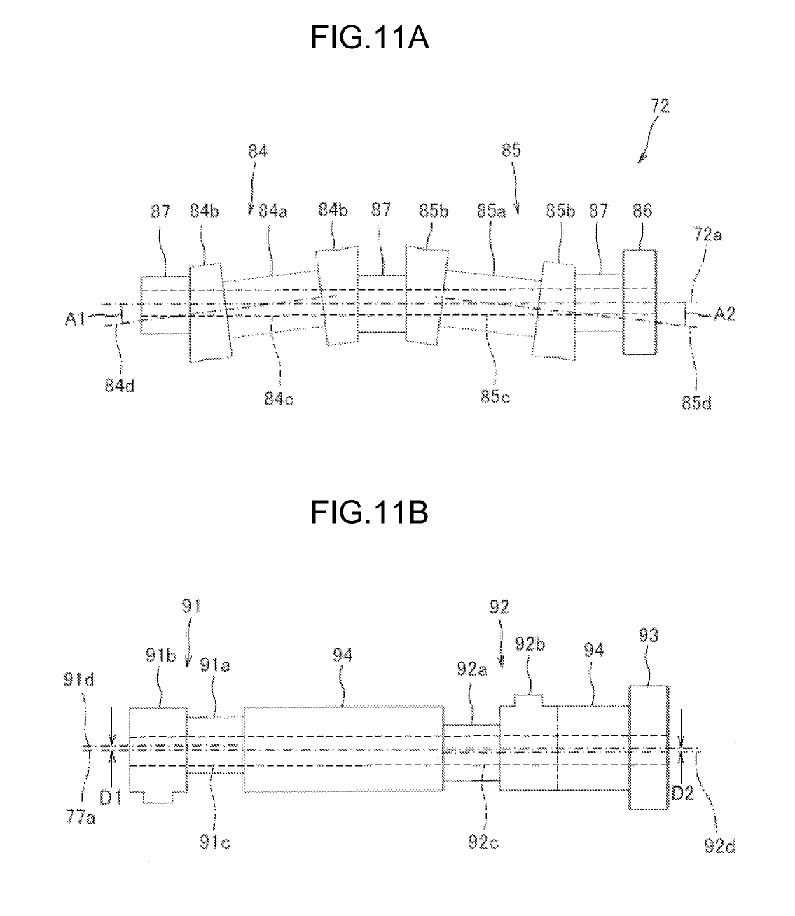

FIG. 9 is a perspective exploded view of a part of a first supporting shaft. FIG. 10 is a perspective exploded view of a part of a second supporting shaft. Specifically, FIG. 9 is an exploded perspective view of a part of the second supporting shaft 72, and FIG. 10 is an exploded perspective view of a part of the second supporting shaft 77. In addition, FIGS. 11A and 11B are planar enlarged views of parts of a first supporting shaft and a second supporting shaft, where FIG. 11A shows the first supporting shaft and FIG. 11B shows the second supporting shaft. Specifically, FIG. 11A is enlarged planar views of parts of the first supporting shaft 72.

As shown in FIG. 9, the first supporting shat 72 is configured by a combination of a plurality of components to be bilaterally symmetric and provided with a main shaft 83 that is long in the horizontal direction. This main shaft 83 has a cylindrical part 83a with an axial center in the horizontal direction, and a shaft part 83b provided extending horizontally outward from the left and right end portions of the cylindrical part 83a. The shaft part 83b has a substantially rectangular cross-section shape, and four corners in the circumferential direction are chamfered. In addition, a pair of inner inclined shaft members 84,84, a pair of outer inclined shaft members 85,85, and a pair of end members 86,86 are inserted into each of the left and right shaft parts 83b, and the inclined shaft members 84 and 85 and the end member 86 are located at predetermined positions in the longitudinal direction of the shaft part 83b by spacers 87 interposed therebetween.

More specifically, the inner inclined shaft member 84 is fitted onto a part, which is the closest to the cylindrical part 83a, in the shaft part 83b with the cylindrical spacer 87 interposed with the cylindrical part 83a. This inner inclined shaft member 84 each includes an inclined shaft part 84a, which has a cylindrical shape with a small diameter, onto which the bearing hole 70a (see FIG. 8) of the inner connecting rod 70 is fitted, a brim part 84b that extends in the diameter expansion direction from the both ends thereof and has a cylindrical shape with a large diameter, and a through hole 84c formed to penetrate through the inclined shaft part 84a and the brim part 84b. The inner inclined shafts 84a,84a have different angles with respect to the axial center 72a. In other words, the axial centers of the inner inclined shafts 84a,84a are angled differently and do not coincide with the axial direction of the axial center 72a.

As shown in FIG. 11A, the axial centers 84d of the inclined shaft part 84a and the brim part 84b are substantially coincident with each other, and the through hole 84c is provided to be inclined by a predetermined angle A1 (>0) with respect to the axial centers 84d. Accordingly, the axial centers 84d of the inclined shaft part 84a and the brim part 84b are inclined by the angle A1 with respect to the axial center 72a of the shaft part 83b when the shaft part 83b is inserted into the through hole 84c of the inner inclined shaft member 84.

In addition, an outer inclined shaft member 85 is provided outside the inner inclined shaft member 84 in the horizontal direction to interpose the spacer 87. This outer inclined shaft member 85 has the same configuration as that of the aforementioned inner inclined shaft member 84 and includes an inclined shaft part 85a, which has a cylindrical shape with a small diameter, onto which the bearing hole 71a (see FIG. 8) of the outer connecting rod 71 is fitted. and a brim part 85b having a cylindrical shape with a large diameter and a through hole 85c penetrate through the inclined shaft part 85a and the brim part 85b. As shown in FIG. 11B, the axial centers 85d of the inclined shaft part 85a and the brim part 85b are substantially coincident with each other, and the through hole 85c is provided to be inclined by a predetermined angle A2 (>0) with respect to the axial center 85d. Accordingly, the axial centers 85d of the inclined shaft part 85a and the brim part 85b are inclined by the angle A2 with respect to the axial center 72a of the shaft part 83b when the shaft part 83b is inserted into the through hole 85c of the outer inclined shaft member 85.

In addition, a ring-shaped end member 86 is disposed outside the outer inclined shaft member 85 in the horizontal direction to interpose the spacer 87. Moreover, the inner inclined shaft member 84 and the outer inclined shaft member 85 are fixed to the shaft part 83b by press-fitting a latch pin 88 into holes 84e and 85e formed so as to penetrate the respective brim parts 84b and 85b in the diameter direction and allowing the tip end of the latch pin 88 to abut on the circumferential surface of the shaft part 83b.

Incidentally, the axial center 84d of the inner inclined shaft member 84 and the axial center 85d of the outer inclined shaft member 85 are not parallel with each other and inclined with different angles with respect to the axial center 72a of the first supporting shaft 72, as shown in FIG. 11A. The inner inclined shaft member 84 and the outer inclined shaft member 85 are provided to be inclined in the opposite directions with respect to the axial center 72a in the planar view. The acute angle A1 between the axial center 84d of the inner inclined shaft member 84 and the axial center 72a is set slightly larger than the acute angle A2 between the axial center 85d of the outer inclined shaft member 85 and the axial center 72a (A1>A2) in this embodiment, in particular. In addition, the axial centers 84d of the left and right inner inclined shaft members 84 are not parallel with each other and are inclined with different angles with respect to the axial center 72a of the first supporting shaft 72m while the axial centers 85d of the left and right outer inclined shaft members 85 are not parallel with each other and are inclined with different angles with respect to the axial center 72a of the first supporting shaft 72. The left and right inner inclined shaft members 84 are inclined in mutually opposite directions with respect to the axial center 72a in the planar view, and the left and right outer inclined shaft members 85 are inclined in mutually opposite directions with respect to the axial center 72a in the planar view (see FIG. 8 as well).

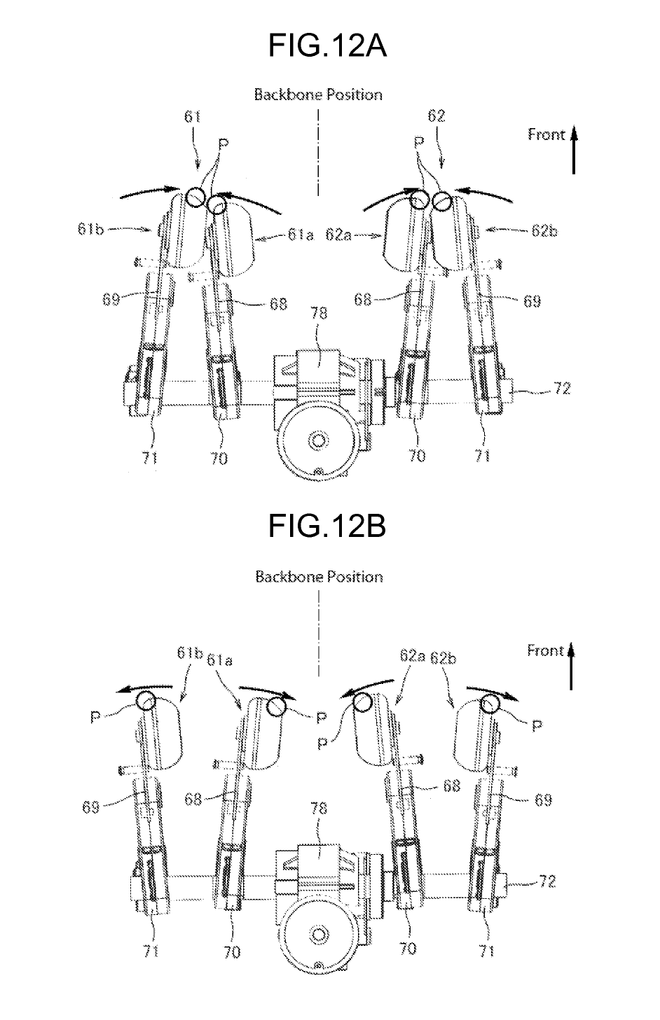

FIGS. 12A and 12B are planar views illustrating operations of an inner treatment element and an outer treatment element when a first supporting shaft is rotated, where FIG. 12A shows a state in which the inner treatment element and the outer treatment element are in positions close to each other and FIG. 12B shows a state in which the inner treatment element and the outer treatment element are separated from each other, respectively. Specifically, FIGS. 12A and 12B are planar views illustrating operations of inner treatment elements 61a and 62a and outer treatment elements 61b and 62b when a first supporting shaft 72 is rotated, where FIG. 12A shows a state in which the inner treatment elements 61a and 62a and the outer treatment elements 61b and 62b are in positions close to each other and FIG. 12B shows a state in which the inner treatment elements 61a and 62a and the outer treatment elements 61b and 62b are separated from each other. As shown in FIGS. 12A and 12B, the distance, by which the inner treatment elements 61a and 62a supported by the inclined shaft part 84a via the connecting rod 70 and the arm 68 are separated from the outer treatment elements 61b and 62b supported by the inclined shaft part 85a via the connecting rod 71 and the arm 69 in the horizontal direction, is changed when the first supporting shaft 72 as described above is driven by the first motor 80 (see FIG. 70) and rotated about the axial center 72a. In addition, the symbol P in FIG. 12 represents a main position at which each of the treatment elements 61a, 61b, 62a, and 62b is in contact with the back of the person when the massage mechanism 9 is positioned in the backrest part 4.

In addition, it is possible to maintain the inner treatment elements 61a and 62a and the outer treatment elements 61b and 62b with an arbitrary separation dimension between the close position state shown in FIG. 12A and the separated position state shown in FIG. 12B by appropriately stopping the first motor 80. Moreover, it is possible to independently perform kneading massage on the left and right halves of the body supported by the backrest part 4 by positioning the massage mechanism 9 in the backrest part 4 and sequentially driving the first motor 80 to repeatedly allow the inner treatment elements 61a and 62a and the outer treatment elements 61b and 62b to approach and separated from each other. That is, it is possible to independently perform a kneading massage on the left half of the body to pinch the left half of the body from the left and right directions by a pair of inner treatment element 61a and the outer treatment element 61b and independently perform kneading massage on the right half of the body to pinch the right half of the body from the left and right directions by a pair of inner treatment element 62a and the outer treatment element 62b. If attention is paid to the left and right inner treatments 61a and 62a, the kneading massage may cross over and pinch the backbone of the person from the left and right directions since the left and right inner treatment elements 61a and 62a approach and separated from each other by the rotation of the first supporting shaft 72. Moreover, it is also possible to perform a massage on the side surfaces (armpits, for example) of the upper body by the pair of outer treatment elements 62a and 62b.

In addition, it is possible to independently perform kneading massage on the left and right parts in the hip area and the femoral area so as to pinch the left and right parts from the left and right directions in the same manner as in the upper body by driving the elevation motor 14, moving the massage mechanism 9 to the seat part 3, and sequentially driving the first motor 80. Moreover, it is possible to independently perform a kneading massage on the left leg by pinching the left leg from the left and right directions by the pair of inner treatment element 61a and the outer treatment element 61b and independently perform kneading massage on the right leg by pinching the right leg from the left and right directions by the pair of inner treatment element 62a and the outer treatment element 62b, by driving the elevation motor 14, moving the massage mechanism 9 to the footrest 5, and sequentially driving the first motor 80.

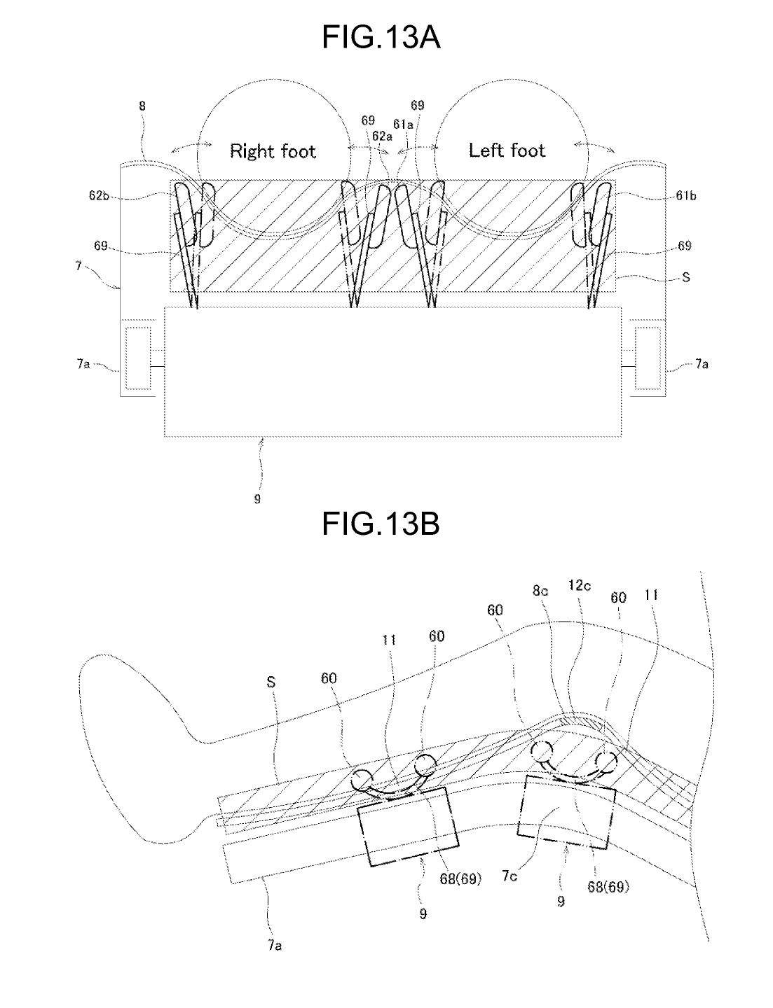

FIGS. 13A and 13B are diagrams for illustrating the operations of the treatment elements for a person's legs, where FIG. 13A is a diagram schematically showing a main chair body when viewed from a side of toes and FIG. 13B is a diagram schematically showing the main chair body when viewed from a left side.

As shown in FIG. 13, the knees of the person sink to a small extent into the movement region S of the massage mechanism 9 shown by a two-dotted chain line, which makes it is possible to perform kneading massage on the back surface of the knees of the person by the inner treatment elements 61a and 62a and the outer treatment elements 61b and 62b since the knees are supported by the curved part 8c (the first supporting portion) near the boundary portion between the seat part 3 and the footrest 5 in the body supporting part 8, in which the degree of flexibility is small. Further, the portions of the legs other than the knees (calves and the like) sufficiently sink into the movement region S of the massage mechanism 9 shown by one-dotted chain line, which makes it and it is possible to independently perform a kneading massage on the left calf by pinching the left calf from the left and right directions by the pair of inner treatment element 61a and the outer treatment element 61b and independently perform kneading massage on the right calf by pinching the right calf from the left and right directions by the pair of inner treatment element 62a and the outer treatment element 62b since the other leg parts than the knees are supported by a part (second supporting portion) in the body supporting part 8 in which the degree of flexibility is large.

In this embodiment, the angles A1 and A2 shown in FIG. 11A are set in the relation of A1>A2 as described above, and the operation range of the inner treatment elements 61a and 62a in the horizontal direction is greater than that of the outer treatment elements 61b and 62b in the horizontal direction when the first supporting shaft 72 is rotated. With such a configuration, the interference with the main body frame 7 in the main chair body 2 is prevented when the outer treatment elements 61b and 62b are moved horizontally outward, and the changeable range of the relative distance between the inner treatment elements 61a and 62a and the outer treatment elements 61b and 62b is widely secured. In addition, the angle A1 for setting the operation range of the inner treatment elements 61a and 62a is set in consideration of preventing the interference between the connecting rod 70 and the gear box 78 and the distance to the outer treatment elements 61b and 62b when the inner treatment elements 61a and 62a are in the close positions to the outer treatment elements 61b and 62b. In addition, the angles A1 and A2 set as described above are examples, and it is also possible to set the angles in a different relation in accordance with the circumferential configuration and other conditions and set the angles so as to satisfy the relation of A1=A2.

On the other hand, the second supporting shaft 77 is configured by a combination of a plurality of components to be bilaterally symmetric and provided with a main shaft 90 with a long dimension in the horizontal direction as shown in FIG. 10. This main shaft 90 has a cylindrical part 90a with an axial center in the horizontal direction, and a shaft part 90b is provided to extend horizontally outward from the left and right end portions of the cylindrical part 90a. The shaft part 90b has a substantially rectangular cross-section shape, and four corners in the circumferential direction are chamfered. In addition, a pair of inner eccentric shaft members 91,91, a pair of outer eccentric shaft members 92,92, and a pair of end members 93,93 are inserted into each of the left and right shaft parts 90b, and the eccentric shaft members 91 and 92 and the end member 93 are located at predetermined positions in the longitudinal direction of the shaft part 90b by spacers 94 interposed therebetween.

Specifically, the inner eccentric shaft member 91,91 is fitted onto the portion closest to the cylindrical part 90a in the shaft part 90b. This inner eccentric shaft member 91,91 includes an eccentric shaft part 91a,91a, which has a cylindrical shape with a small diameter and is provided corresponding to the inner treatment elements 61a and 62a, onto which the bearing hole 75a (see FIG. 8) of the bearing member 75 is fitted, a brim part 91b which extends in the diameter expansion direction from the inner end of the eccentric shaft part 91a,91a in the horizontal direction and has a cylindrical shape with a large diameter, and a through hole 91c formed to penetrate through the eccentric shaft part 91a,91a and the brim part 91b in the horizontal direction. The inner eccentric shaft parts 91a,91a are eccentric with respect to the axial center such that phases about the axial center 77a are different from each other.

Here, the axial center of the through hole 91c is eccentric by a predetermined dimension from the axial center 91d of the eccentric shaft part 91a,91a. Accordingly, the axial center 91d of the eccentric shaft part 91a,91a is positioned to be eccentric by a predetermined dimension D1 with respect to the axial center 77a of the second supporting shaft 77 when the shaft part 90b is inserted into the through hole 91c of the inner eccentric shaft member 91 as shown in FIG. 11B.

In addition, an outer eccentric shaft member 92 is disposed outside the inner eccentric shaft member 91 in the horizontal direction with a spacer 94 interposed therebetween. This outer eccentric shaft member 92 has the same configuration as that of the aforementioned inner eccentric shaft member 91 and has an eccentric shaft part 92a, which has a cylindrical shape with a small diameter and is provided corresponding to the outer treatment elements 61b and 62b, onto which the bearing hole 76a (see FIG. 8) of the bearing member 76 is fitted, a brim part 92b that extends in the diameter expansion direction from the outer end of the eccentric shaft part 92a in the horizontal direction and that has a cylindrical shape with a large diameter, and a through hole 92c which penetrates through the eccentric shaft part 92a and the brim part 92b in the horizontal direction is formed. The axial center of the through hole 92c is also eccentric by a predetermined dimension from the axial center 92d of the eccentric shaft part 92a. Accordingly, the axial center 92d of the eccentric shaft part 92a is positioned to be eccentric by a predetermined dimension D2 with respect to the axial center 77a of the second supporting shaft 77 when the shaft part 90b is inserted into the through hole 92c of the outer eccentric shaft member 92 as shown in FIG. 11B.

In addition, a ring-shaped end member 93 is disposed outside the outer eccentric shaft member 92 in the horizontal direction with a spacer 94 interposed therebetween. Moreover, the inner eccentric shaft member 91 and the outer eccentric shaft member 92 inserted into the shaft part 90b as described above is fixed to the shaft part 90b by press-fitting a latch pin 95 into holes 91e and 92e to penetrate through the brim parts 91b and 92b in the diameter direction and by allowing the tip end of the latch pin 95 to abut on the circumferential surface of the shaft part 90b.

Incidentally, the axial center 91d of the inner eccentric shaft member 91 and the axial center 92d of the outer eccentric shaft member 92 have different phases about the axial center 77a of the second supporting shaft 77 as shown in FIG. 11B, and more specifically, the axial center 91d of the inner eccentric shaft member 91 and the axial center 92d of the outer eccentric shaft member 92 are configured to have a phase difference of 180°, in this embodiment. Accordingly, when the second supporting shaft 77 is driven by the second motor 81 (see FIG. 7) and rotated about the axial center 77a, the relative protruding dimensions of the inner treatment elements 61a and 62a and the outer treatment elements 61b and 62b toward the side of the back surface of the body of the person are changed. In addition, the axial centers 91d of the left and right inner eccentric shaft members 91 have different phases about the axial center 77a of the second supporting shaft 77, and more specifically, the axial centers 91d of the left and right inner eccentric shaft members 91 are configured to have a phase difference of 180°. The axial centers 92d of the left and right outer eccentric shaft members 92 have different phases about the axial center 77a of the second supporting shaft 77, and more specifically, axial centers 92d of the left and right outer eccentric shaft members 92 are configured to have a phase difference of 180° (see FIG. 8 as well). Accordingly, when the second supporting shaft 77 is driven by the second motor 81 (see FIG. 7) and rotated about the axial center 77a, the relative protruding dimensions of the left and right inner treatment elements 61a and 62a toward the back the person are respectively changed, and the relative protruding dimensions of the left and right outer treatment elements 61b and 62b toward the back the person are respectively changed.

Therefore, it is possible to maintain the inner treatment elements 61a and 62a and the outer treatment elements 61b and 62b at arbitrary positions within a range in which advance and retreat operations are available by appropriately stopping the second motor 81. Moreover, it is possible to cause the inner treatment elements 61a and 62a and the outer treatment elements 61b and 62b to repeatedly and alternately perform advance and retreat operations and independently perform a tapping massage on the left and right halves of the body supported by the backrest part 4 by positioning the massage mechanism 9 in the backrest part 4 and sequentially driving the second motor 81. It is also possible to perform a tapping massage on the muscles of the back, which is the horizontal center of the back supported by the backrest part 4, by causing the left and right inner treatment elements 61a and 62a to repeatedly and alternately perform advance and retreat operations. That is, the pair of inner treatment element 61a and the outer treatment element 61b can perform a tapping massage on the left half of the body as if a massager actually performed with his or her hands, and the pair of inner treatment element 62a and the outer treatment element 62b can perform the same tapping massage on the right half of the body independently from the left half of the body. Furthermore, the pair of inner treatment elements 61a and 62a can perform a tapping massage on the muscles of the back, and the pair of outer treatment elements 61b and 62b can perform tapping massage on the side surfaces (armpits, for example) of the upper body.

In addition, it is possible to independently perform a tapping massage on the hip area and the femoral area in the same manner as in the upper body and on the horizontal center portion of the hip area and the femoral area by driving the elevation motor 14 to move the massage mechanism 9 to the seat part 3 and sequentially driving the second motor 81. In addition, it is possible to independently perform a tapping massage on the left and right legs in the same manner as in the upper body by the pair of inner treatment element 61a and the outer treatment element 61b by driving the elevation motor 14 to move the massage mechanism 9 to the footrest 5 and sequentially driving the second motor 81.

In addition, since the massage mechanism 9 according to this embodiment can independently operate the first motor 80 and the second motor 81, it is possible to perform a tapping massage by driving the second motor 81 while the distance by which the inner treatment elements 61a and 62a and the outer treatment elements 61b and 62b are separated in the horizontal direction is set in accordance with the preference of the person by driving the first motor 80. In addition, it is also possible to perform a kneading massage by driving the first motor 80 while the relative protruding dimensions of the inner treatment elements 61a and 62a and the outer treatment elements 61b and 62b are set in accordance with the preference of the person by driving the second motor 81. With such a configuration, it is possible to expand the kneading and tapping massage target ranges in the person and perform a massage on a desired part or range by moving the inner treatment elements 61a and 62a and the outer treatment elements 61b and 62b even if the person does not move his or her body. Furthermore, it is possible to achieve various massage effects by simultaneously driving the first motor 80 and the second motor 81 or changing the rotation speed and the rotation direction during the drive.

### Another Configuration 1 of Massage Mechanism

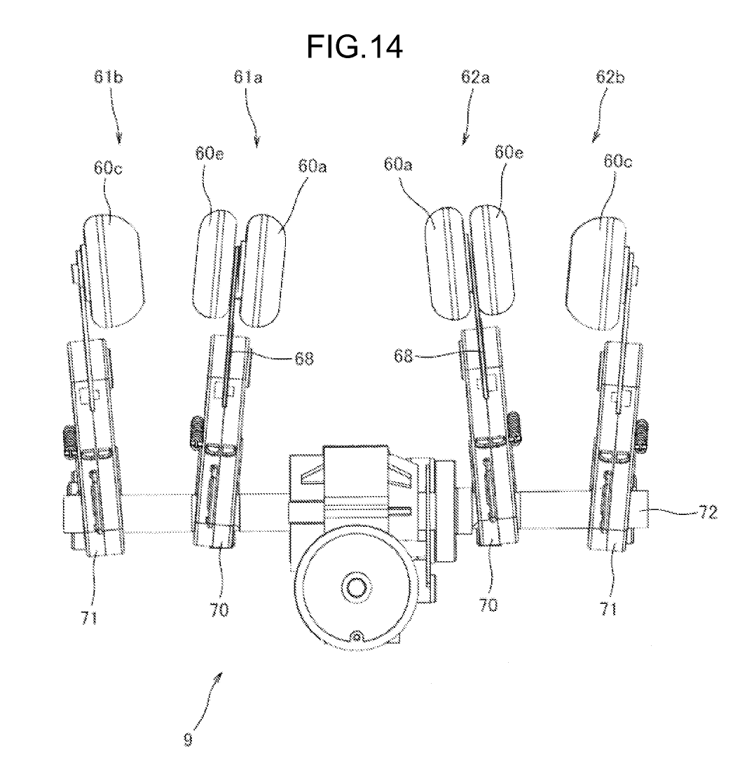

FIG. 14 is a planar view showing another configuration which can be applied to a massage mechanism. Specifically, FIG. 14 is a planar view showing another configuration which can be applied to the massage mechanism 9. In the massage mechanism 9 shown in FIG. 14, the left and right inner treatment elements 61a and 62a are provided with one more treatment element 60e in addition to the treatment element 60a which was described above as an upper treatment element. More specifically, although the treatment element 60a is pivoted only in the inner side surface in the horizontal direction at the upper and lower tip ends of the arm 68 in the massage mechanism 9 described above with reference to FIGS. 6 and the like, the treatment element 60e is also pivoted in the outer side surface on the opposite side in the massage mechanism 9 shown in FIG. 14. In addition, the treatment elements 60a and 60e are configured to have smaller dimensions as compared with the outer treatment element 60c, and particularly, the treatment elements 60a, and 60e are configured to have a smaller thickness dimension. Moreover, the treatment element 60e may be also provided at a corresponding position on the opposite side of the lower treatment element 60b on the outer side surface of the arm 68. Since the configuration of the massage mechanism 9 shown in FIG. 14 is the same as that of the aforementioned massage mechanism 9 except for the point in that the treatment element 60e is added in the configuration of the massage mechanism 9 shown in FIG. 14, the description of the other configurations will be omitted.

Accordingly, the first motor 80 is driven to perform the kneading massage on the upper body, it is possible to perform a kneading massage on the backbone with the treatment elements 60a and 60a respectively included in the left and right inner treatment elements 61a and 62a and to perform a kneading massage on the part near the left armpit by the treatment element 60e of the inner treatment element 61a and the treatment element 60c of the outer treatment element 61b corresponding to the left half of the body. Similarly, it is possible to perform a kneading massage on the part near the right armpit by the treatment element 60e of the inner treatment element 62a and the treatment element 60c of the outer treatment element 62b corresponding to the right half of the body. In addition, when the first motor 80 is driven to perform a kneading massage on the legs, it is possible to pinch the left leg and perform kneading massage thereon by the treatment element 60e of the inner treatment element 61a and the treatment element 60c of the outer treatment element 61b and it is possible pinch the right leg and perform kneading massage thereon by the treatment element 60e of the inner treatment element 62a and the treatment element 60c of the outer treatment element 62b. Moreover, it is possible to employ a dedicated treatment element in accordance with the characteristics (a muscle amount, a shape of a body, a skeleton, acuity, and the like) of each treated part since there are treatment elements provided to respectively correspond to each treated part as described above.

### Configuration Relating to Rocking Operation

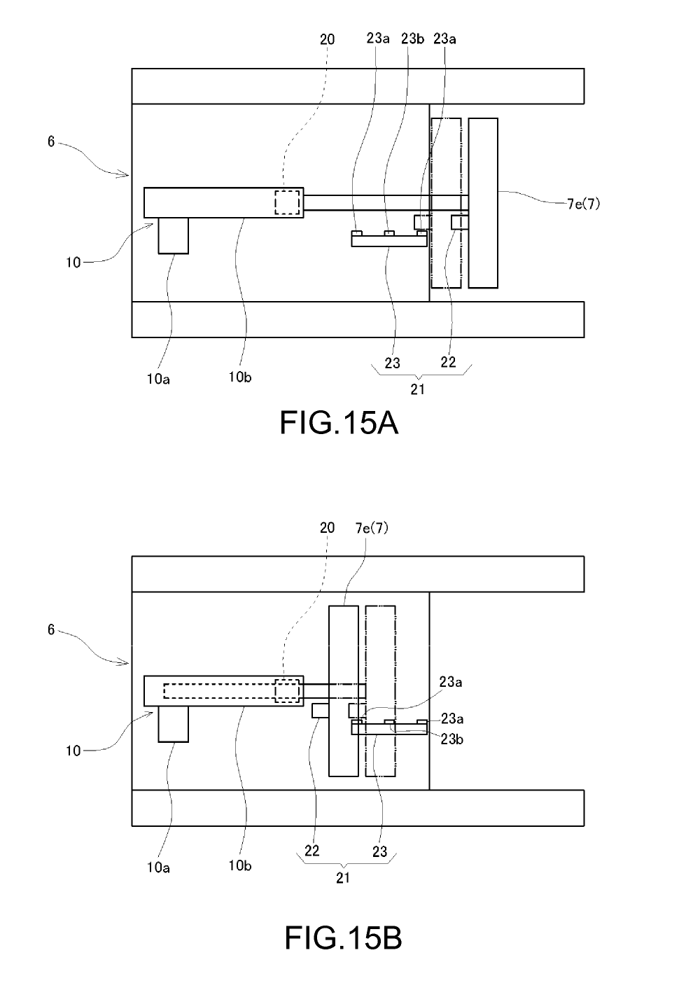

The rocking operation of the massage machine 1 will now be described with reference to FIGS. 1 to 5 and FIGS. 15A and 15B. FIGS. 15A and 15B are planar views schematically showing a positional relationship between a leg frame and a main body frame, where FIG. 15A shows a state in which a main chair body is in a front position or a first predetermined position and FIG. 15B shows a state in which the main chair body is in a back position or a first predetermined position, respectively. Specifically, FIGS. 15A and 15B are planar view schematically showing a positional relation between the leg frame 6 and the main body frame, where FIG. 15A shows a state in which the main chair body is in a front position or a first predetermined position and FIG. 15B shows a state in which the main chair body is in a back position or a first predetermined position.

The massage machine 1 according to the present invention is provided with a main chair body 2 including a seat part 3 on which a person is seated, a backrest part 4 on which a person leans, a leg frame 6 that supports the main chair body 2 and to be able to swing in the front-back direction, a swing driving part 10 that swings the main chair body 2 in the front-back direction, and a control part 50 that controls the swing speed to be decelerated before the ends of the track in the front-back direction during the reciprocating swing of the main chair body 2 in the front-back direction.

With such a configuration, it is possible to smoothly control the swing direction of the main chair body 2 and provide comfortable swing.

In addition, a first sensor 20 that detects the position of the main chair body 2 at the end of the track and a second sensor 21 that detect a first predetermined position of the main chair body 2 before the end of the track are provided, and the control part 50 controls the swing speed of the main chair body 2 to be decelerated when the second sensor 21 detects the first predetermined position.

Thus, it is possible to precisely detect the first predetermined position of the main chair body 2 before the end of the track and secure the time for allowing the swing of the main chair body 2 to be decelerated.

In addition, the swing driving part 10 includes a motor 10a and a rod 10b, which is driven (extended and contracted) by the motor 10a. The first sensor 20 is configured to detect the extension/contraction stroke end of the rod 10b, and the control part 50 controls the rotation direction of the motor 10a to be switched such that the swing direction of the main chair body 2 is reversed when the first sensor 20 detects the extension/contraction stroke end of the rod 10b.

With such a configuration, it is possible to smoothly switch the swing direction of the main chair body 2 even when the swing driving part 10 is simply configured.

In addition, the second sensor 21 is configured to detect a second predetermined position between the front and back first predetermined positions.

With such a configuration, it is possible to detect the second predetermined position between the ends of track of the main chair body 2 and change a range in which the main chair body 2 reciprocally swings. For example, it is possible to set the range in which the main chair body 2 reciprocally swings in various manners such as between the front and back track ends, between the front track ends and the second predetermined position, or between the back track end and the second predetermined position.

As shown in FIG. 15, the aforementioned swing driving part 10 includes a motor 10a and a rod 10b, which is driven by the motor 10a, being extended and contracted. This motor 10a is electrically connected to the control part 50 and can be operated by pre-set program in advance in response to the instruction from the control part 50 and by the operation of the remote controller 55 connected to the control part 50 by the person (see FIG. 5). In addition, the rotation speed and the rotation direction of the motor 10a are appropriately set in response to the instruction from the control part 50. The swing speed of the main chair body 2 corresponds to the rotation speed of the motor 10a, and the swing direction of the main chair body 2 corresponds to the rotation direction of the motor 10a. In addition, the rod 10b includes a first sensor 20 that detects own extension/contraction stroke end and is configured to be able to detect the most extended state (the front position state shown in FIG. 3) and the most contracted state (the back position state shown in FIG. 4). This first sensor 20 is electrically connected to the control part 50.

As shown in FIGS. 15A and 15B, the massage machine 1 of the present invention is provided with a second sensor 21 which detects the predetermined front back positions of the main chair body 2 with respect to the leg frame 6. This second sensor 21 is a non-contact type sensor and includes a detected body 22 made of a magnetic body or the like provided in the coupling member 7e of the main body frame 7 and a detecting body 23 made of a hall IC or the like provided in the leg frame 6. A plurality of (three in this embodiment) detecting bodies 23 are provided in the front-back direction and include detecting bodies 23a, which detect the first predetermined position before the track end (near the track end) of the main chair body 2, and the detecting body 23b, which detects the second predetermined position between the front and back first predetermined positions. This second sensor 21 is electrically connected to the control part 50. In addition, as can be understood from FIGS. 3, 4, 15A, and 15B, the coupling member 7e is located in the back position as the main chair body 2 approaches the front position state, while the coupling member 7e is located in the front position as the main chair body 2 approaches the back position state.

In this embodiment, the first predetermined positions are positions before the main chair body 2 is brought in the front position state and the back position state shown in FIGS. 3 and 4. The second predetermined position is a substantially middle position between the front position state and the back position state. As shown in FIG. 15A, the first sensor 20 can detect the main body frame 7 (shown by a solid line) in the front position, and the second sensor 21 can detect the main body frame 7 (shown by a two-dotted chain line) in the first predetermined position. As shown in FIG. 15B, the first sensor 20 can detect the main body frame 7 (shown by a solid line) in the back position, and the second sensor can detect the main body frame 7 (shown by two-dotted chain line) in the first predetermined position.

The control part 50 controls the motor 10a to decelerate the rotation speed when the detecting body 23a detects the passing of the detected body 22 while the main chair body 2 is allowed to swing in the front back direction with respect to the leg frame 6. In addition, the control part 50 controls the motor 10a to reverse the rotation direction when the first sensor 20 detects that the main chair body 2 has reached the track end (the front position state or the back position state). That is, the control part 50 decelerates the swing speed of the main chair body 2 to the backward when the second sensor 21 detects that the main chair body 2 has been in the first predetermined position while the main chair body 2 is made to swing backward from the front position state. Then the control part 50 switches the swing direction, and causes the main chair body 2 to swing forward when the first sensor 20 detects that the main chair body 2 has been in the back position state. The control part 50 decelerates the swing speed of the main chair body 2 to the forward when the second sensor 21 detects that the main chair body 2 has been in the first predetermined position while the main chair body 2 is made to swing forward from the back position state, then switches the swing direction, and causes the main chair body 2 to swing backward when the first sensor 20 detects that the main chair body 2 has been in the front position state. The control part 50 repeatedly performs the above cycle.

The control part 50 reverse the rotation direction of the motor 10a when the detecting body 23b detects the passing of the detected body while the main chair body 2 swings reciprocally in the front-back direction with respect to the leg frame 6, and the range in which the main chair body 2 swings reciprocally can be set in various manners, such as between the front and back track ends, between the front track end and the second predetermined position, or between the back track end and the second predetermined position. The range in which the main chair body 2 swings reciprocally may be set by to the operation of the remote controller 55 or may be configured to be chronologically variable based on a program set in advance. In the case of the configuration in which the reciprocating swing range is chronologically variable based on the program, it is possible to provide a swing variety for a more relaxed feeling.

The present invention can be applied to a massage machine which can perform massage corresponding to each of the left and right halves of the upper body of a person to be treated, perform massage corresponding to each of the left and right legs for the leg parts, and thereby perform a satisfactory massage from the upper body to the lower body.

What is claimed is:

1. A massage machine, comprising:
a main chair body including a seat part, a backrest part, and a footrest part; and
a massage mechanism provided in the main chair body that is movable along a path between the backrest part and the footrest part;
the massage mechanism comprises:
a pair of first and second inner treatment elements;
a pair of first and second outer treatment elements, wherein the pair of inner treatment elements are between the pair of outer treatment elements;
a driving device that drives the pair of inner treatment elements and the pair of outer treatment elements; and
a first supporting shaft that supports the pair of inner treatment elements and the pair of outer treatment elements, the first supporting shaft is rotated about an axial center by the driving device;
the first supporting shaft comprises:
a pair of inner inclined shafts that respectively support the inner treatment elements via an arm; and
a pair of outer inclined shafts that respectively support the outer treatment elements via the arm;
wherein the pair of the inner inclined shafts has different angles with respect to the axial center, one of the inner inclined shafts and one of the outer inclined shafts have different angles with respect to the axial center;
wherein a first distance between the first inner treatment element and the first outer treatment element is variable by the driving device in the first direction and a second distance between the second inner treatment elements and the second outer treatment elements is variable by the driving device in the first direction; and
wherein the massage mechanism is movable from the backrest part to the footrest part via the seat part.

2. The massage machine of claim 1, further comprising:
a guide rail extending in a height direction of the main chair body along the seat part, the backrest part, and the footrest that guides the movement of the massage mechanism.

3. The massage machine of claim 1, further comprising:
a second supporting shaft that supports the pair of the inner treatment elements and the pair of the outer treatment elements, the second supporting shaft is rotated about the axial center by the driving device;
the second supporting shaft comprises:
a pair of inner eccentric shafts that supports the pair of the inner treatment elements via the arm; and
a pair of outer eccentric shafts that support the pair of the outer treatment elements via the arm;
wherein the pair of the inner eccentric shafts is eccentric with respect to the axial center such that phases about the axial center are different from each other, one of the inner eccentric shafts and one of the outer eccentric shafts are eccentric with respect to the axial center such that phases about the axial center are different from each other; and
wherein the pair of inner treatment elements and the pair of outer treatment elements alternately protrude.

4. The massage machine of claim 1, wherein the main chair body includes:
a body supporting part that is entirely or partially flexible and is configured to support a back surface of a person;
wherein the body supporting part is set to have a smaller degree of flexibility in a near knee part as compared with the other parts.

5. The massage machine of claim 1, wherein the main chair body includes:
a body supporting part that supports the back surface of the person and that is entirely or partially flexible,
wherein the seat part has an inclined shape in which the front thereof is higher and the footrest has an inclined shape in which the front thereof is the lower, and
wherein the body supporting part is set to have a smaller degree of flexibility near a boundary portion between the seat part and the footrest part as compared with the other parts.

6. The massage machine of claim 1, wherein the main chair body comprises:
a body supporting part that is entirely or partially flexible and is configured to support a back surface of a person;
the body supporting part comprises:
a main body cover that covers a front side of the massage mechanism; and
a belt member that is partially provided in front of and separate from the main body cover;
wherein the degree of the flexibility in the belt member is set to be smaller than that in the main body cover.

7. The massage machine of claim 1,
wherein the pair of inner treatment elements are provided on both left and right sides of the arm respectively.
